(19) United States
(12) Patent Application Publication
(10) Pub. No.: US 2024/0054812 A1
(43) Pub. Date: Feb. 15, 2024

(54) IMAGE ACQUISITION APPARATUS, IMAGE ACQUISITION METHOD, AND NON-TRANSITORY COMPUTER-READABLE STORAGE MEDIUM

(71) Applicant: NEC Corporation, Tokyo (JP)

(72) Inventors: Keiju NAKAMURA, Tokyo (JP); Hiroaki Kiso, Tokyo (JP)

(73) Assignee: NEC Corporation, Tokyo (JP)

(21) Appl. No.: 18/229,472

(22) Filed: Aug. 2, 2023

(30) Foreign Application Priority Data
Aug. 12, 2022 (JP) 2022-129010

(51) Int. Cl. G06V 40/16; G06V 10/70

(52) U.S. Cl. CPC G06V 40/172; G06V 10/70; G06V 40/166

(57) ABSTRACT

An image acquisition apparatus includes an output control unit and an image acquisition unit. The output control unit causes an output unit to output a content. The image acquisition unit acquires an image generated by an image capture unit, the image includes a person and is an image for authentication. The image capture unit is located in a position where a face of the person can be captured when the person faces to the output unit. Further, the output control unit continues to cause the output unit to output the content until a first condition being set in order to make the authentication succeed is satisfied.

This application is based upon and claims the benefit of priority from Japanese Patent Application No. 2022-129010 filed on Aug. 12, 2022, the disclosure of which is incorporated herein in its entirety by reference.

### TECHNICAL FIELD

The present invention relates to an image acquisition apparatus, image acquisition method, and a program.

### BACKGROUND ART

In recent years, authentication of a person by using a face image is performed in various places. In order to improve accuracy of the authentication, it is preferable that image capturing is performed in a state in which a face is facing forward to an imaging apparatus.

Note that, it is described in Patent Document 1 (Japanese Patent Application Publication No. 2019-219698) that, in an iris authentication apparatus, a display unit is caused to display an attention-calling display for calling attention of a person to be authenticated is displayed. Further, it is described in Patent Document 2 (Japanese Patent Application Publication No. 2008-61092) that, in an automatic photo studio, for a purpose of directing a line of sight of a small child toward a camera, an image display unit is provided near a photographing unit, the image display unit is caused to display an image of a predetermined object moving toward the photographing unit, and photographing unit is caused to photograph when the image of predetermined object comes close to the photographing unit or disappears.

### SUMMARY OF INVENTION

In the above-described Patent Document 1, timing at which an attention-calling display is ended is not clearly described. Therefore, there is a possibility that the display ends before an image with which authentication is possible is acquired. Further, face authentication is not considered in the technique described in Patent Document 2.

In view of the above-described problem, one object of the present invention is to provide an image acquisition apparatus, an authentication system, an image acquisition method, an authentication method, and a program with a high possibility of acquiring an image with which authentication is possible.

According to one aspect of the present invention, an image acquisition apparatus is provided, including:
at least one memory configured to store instructions; and
at least one processor configured to execute the instructions to:
   cause an output unit to output a content;
   acquire an image generated by an image capture unit located in a position where a face of a person can be captured when the person faces to the output unit, the image includes the person and is an image for authentication; and
      continue to cause the output unit to output the content until a first condition being set in order to make authentication succeed is satisfied.

According to one aspect of the present invention, an authentication system is provided, including:
at least one memory configured to store instructions; and
at least one processor configured to execute the instructions to:
   cause an output unit to output a content;
   acquire an image generated by an image capture unit located in a position where a face of a person can be captured when the person faces to the output unit, the image includes the person and is an image for authentication;
   perform authentication processing on the person by using the image; and
   continue to cause the output unit to output the content until a first condition being set in order to make the authentication succeed is satisfied.

According to one aspect of the present invention, an image acquisition method is provided, including, by a computer:
causing an output unit to output a content;
acquiring an image generated by an image capture unit located in a position where a face of a person can be captured when the person faces to the output unit, the image includes the person and is an image for authentication; and
continuing to cause the output unit to output the content until a first condition being set in order to make authentication succeed is satisfied.

According to one aspect of the present invention, an authentication method is provided, including, by an authentication system:
causing an output unit to output a content;
acquiring am image generated by an image capture unit located in a position where a face of a person can be captured when the person faces to the output unit, the image includes the person and is an image for authentication;
performing authentication processing on the person by using the image; and
continuing to cause the output unit to output the content until a first condition being set in order to make authentication succeed is satisfied.

According to one aspect of the present invention, a program is provided, causing a computer to execute:
a process of causing an output unit to output a content;
a process of acquiring an image generated by an image capture unit located in a position where a face of a person can be captured when the person faces to the output unit, the image includes the person and is an image for authentication; and
a process of continuing to cause the output unit to output the content until a first condition being set in order to make authentication succeed is satisfied.

According to one aspect of the present invention, an image acquisition apparatus, an authentication system, an image acquisition method, an authentication method, and a program with a high possibility of acquiring an image sufficient to improve authentication accuracy can be achieved.

### BRIEF DESCRIPTION OF THE DRAWINGS

FIG. 1 is a diagram illustrating an image acquisition apparatus according to an example embodiment.

FIG. 2 is a diagram illustrating one example of a usage environment of the image acquisition apparatus.

FIG. 3 is a diagram illustrating one example of a functional configuration of the image acquisition apparatus.

FIG. 4 is a diagram illustrating one example of a functional configuration of an authentication apparatus.

FIG. 5 is a diagram illustrating one example of information stored in a person storage unit.

FIG. 6 is a diagram illustrating one example of information stored in a content storage unit.

FIG. 7 is a diagram illustrating one example of a hardware configuration of the image acquisition apparatus.

FIG. 8 is a flowchart illustrating one example of processing performed by the image acquisition apparatus and the authentication apparatus.

FIG. 9 is a flowchart illustrating a first detailed example of step S30 in FIG. 8.

FIG. 10 is a flowchart illustrating a second detailed example of step S30 in FIG. 8.

FIG. 11 is a diagram for describing a function of an image acquisition apparatus according to a second example embodiment.

FIG. 12 is a diagram illustrating one example of a functional configuration of an image acquisition apparatus according to a third example embodiment.

FIG. 13 is a flowchart illustrating one example of processing performed by the image acquisition apparatus and the authentication apparatus.

### EXAMPLE EMBODIMENT

The following example embodiments of the present invention are described with reference to the drawings. Note that, in all the drawings, a similar component is denoted with a similar reference sign, and description thereof is not included as appropriate.

### First Example Embodiment

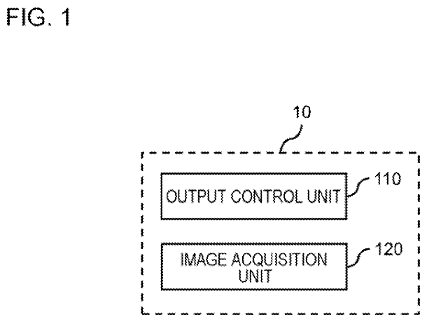

FIG. 1 is a diagram illustrating an outline of an image acquisition apparatus 10 according to an example embodiment. The image acquisition apparatus 10 includes an output control unit 110 and an image acquisition unit 120. The output control unit 110 causes an output unit to output a content. The image acquisition unit 120 acquires an image generated by an image capture unit, the image includes a person and is an image for authentication. The image capture unit is located in a position where a face of the person can be captured when the person faces to the output unit. Further, the output control unit 110 continues to cause the output unit to output the content until a first condition being set in order to make the authentication succeed is satisfied.

Herein, when the content includes at least one of a still image and a moving image, the output unit includes a display. Further, when the content includes audio, the output unit includes a speaker.

The image acquisition apparatus 10 may include at least one of the image capture unit and the output unit. However, the image capture unit may be a separate apparatus from the image acquisition apparatus 10, and the output unit may be a separate apparatus from the image acquisition apparatus 10.

According to the image acquisition apparatus 10, a possibility of acquiring an image sufficient to improve authentication accuracy is increased.

In the following, a detailed example of the image acquisition apparatus 10 is described.

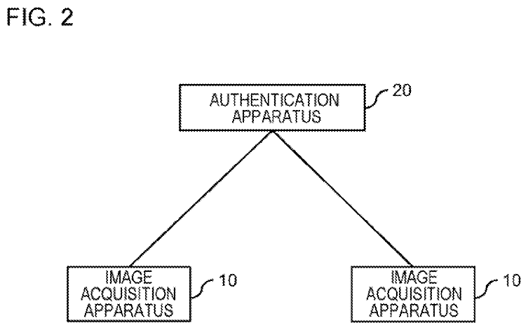

FIG. 2 is a diagram illustrating one example of a usage environment of the image acquisition apparatus 10. In the example illustrated in the present drawing, the image acquisition apparatus 10 is used together with an authentication apparatus 20 that performs authentication processing. The authentication apparatus 20 may be used together with a plurality of the image acquisition apparatuses 10. In this case, the authentication apparatus 20 may function as a server. The image acquisition apparatus 10 and the authentication apparatus are at least part of an authentication system.

The image acquisition apparatus 10 is a portable terminal such as a smartphone or a tablet terminal, and is operated by a subject to be authenticated or by an assistant who assists the subject. One example of the subject is a user of a facility such as a nursing home, a hospital, and the like, or a user of an in-home care service. In this case, the assistant is a person who works in the facility or a person who provides the in-home care service, for example, a care worker and a nurse. In this case, the authentication apparatus 20 may be a terminal operated by the assistant.

When the image acquisition apparatus 10 acquires an image for face authentication, the authentication apparatus 20 transmits a content to the image acquisition apparatus 10. Then, the image acquisition apparatus 10 causes the output unit to output the content. The image capture unit repeatedly generates images including a face of the subject while the output unit is outputting the content. The output unit and the image capture unit are mounted on the image acquisition apparatus 10. The image acquisition apparatus 10 transmits the image to the authentication apparatus 20. The authentication apparatus 20 performs authentication processing on the subject by using the image. After the authentication processing is succeeded, at least one of the image acquisition apparatus 10 and the authentication apparatus 20 performs predetermined processing.

One example of the predetermined processing is processing for managing a medication history of the subject, but is not limited thereto. For example, the predetermined processing is processing for assisting communication between the subject and a relative of the subject, for example, processing of outputting a moving image transmitted from the relative to the subject. The moving image is, for example, a video message from the relative to the subject.

Further, another example of the predetermined processing is to transmit that authentication is succeeded to another terminal. When the image acquisition apparatus 10 is operated by the subject, one example of the another terminal is a terminal operated by the assistant. Further, the another terminal performs various pieces of processing related to the subject.

Note that, the output unit that outputs a content and the image capture unit that generates an image may be a separate apparatus from the image acquisition apparatus 10. For example, when the image acquisition apparatus 10 is operated by the assistant, the output unit and the image capture unit may be mounted on a terminal operated by the subject, for example, a portable terminal such as a smartphone and a tablet terminal.

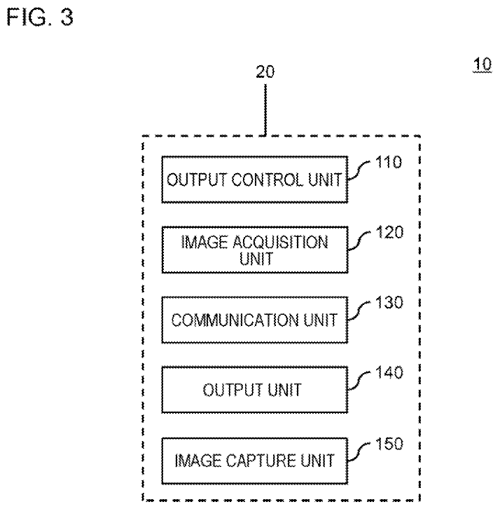

FIG. 3 is a diagram illustrating one example of a functional configuration of the image acquisition apparatus 10. The image acquisition apparatus 10 includes the output control unit 110, the image acquisition unit 120, a communication unit 130, an output unit 140, and an image capture unit 150.

The image capture 150 includes an imaging device, and generates an image including a face of the subject. The image capture unit 150 repeatedly generates images. The image capture unit 150 may repeatedly generate a still image, or may generate a moving image at a predetermined frame rate.

The output unit 140 includes, as an output device, at least one of a display and a speaker, preferably both. The output unit 140 outputs a content.

The content may include, as described above, at least one of a still image and a moving image, or may include audio. The content is preferably information to be changed over time, such as a moving image and audio. As a result, the subject is less likely to be bored with the content, and consequently, more likely to continue his/her face facing to the output unit 140.

Further, the content may be information related to a relative of the subject. One example of the relative is at least one of a parent, a brother, a child, a grandchild, and a great-grandchild. A specific example of the content is at least one of (A) to (C) described below, but is not limited thereto.
(A) At least one of a still image and a moving image of the relative
(B) Audio of the relative
(C) At least one of information on the Internet, a still image, and a moving image selected by the relative

As described with reference to FIG. 1, the output control unit 110 causes the output unit 140 to output the content. Further, the output control unit 110 continues to cause the output unit 140 to output the content until a first condition being set in order to make authentication succeed is satisfied.

A first example of the first condition is a condition related to a face of the subject included in an image generated by the image capture unit 150. A specific example of the condition is, for example, at least one of (1) to (5) described below, but is not limited thereto.
(1) Sharpness of the face included in the image satisfies a criterion
(2) Certainty that an area of a part of the image is the face satisfies a criterion. For example, color of the area is close to color of the face.
(3) In addition to (2) or instead of (2), sharpness of a boundary of an area estimated to be the face and another area (for example, an outline of the face) satisfies a criterion
(4) A size of the face included in the image (or a size of an area of which certainty of being the face satisfies the criterion) is equal to or larger than a reference value
(5) A predetermined part of the face is detectable from the image. One example of the predetermined part includes both eyes, a nose, and a mouth, but is not limited thereto.

A second example of the first condition is a condition related to progress of the authentication processing. A specific example of the condition includes, for example, (6) and
(7) described below, but is not limited thereto.
(6) The authentication processing is succeeded. Note that, one example of a condition for successful authentication processing is that an image of which a score for master facial information satisfies a criterion is present. Note that, when there is master facial information of a plurality of persons, one example of a condition for successful authentication processing is that a master face image of which a score for an image to be processed satisfies a criterion is present. (7) Processing related to authentication is ended. This condition is, for example, after the condition described in (6) is satisfied, and until preparation for further performing predetermined processing such as the processing for managing the medication history of the subject is completed.

The image acquisition unit 120 acquires an image generated by the image capture unit 150.

The communication unit 130 communicates with the authentication apparatus 20. In the communication, the communication unit 130 acquires a content from the authentication apparatus 20. The communication unit 130 may acquire, from the authentication apparatus 20, only a content to be actually output by the output control unit 110, or may acquire a plurality of contents. In the latter case, the output control unit 110 selects, from the plurality of contents acquired from the authentication apparatus 20, a content to be output by the output unit 140.

Further, the communication unit 130 transmits an image for authentication to the authentication apparatus 20. Note that, the communication unit 130 may generate a feature value of a face by processing the image for authentication, and transmit the feature value to the authentication apparatus 20. In the following description, when information transmitted from the image acquisition apparatus 10 to the authentication apparatus 20 is referred to as an “image”, it is assumed that a case in which a feature value of a face is transmitted instead of an image is also included. Further, the communication unit 130 may transmit other information to the authentication apparatus 20, as necessary.

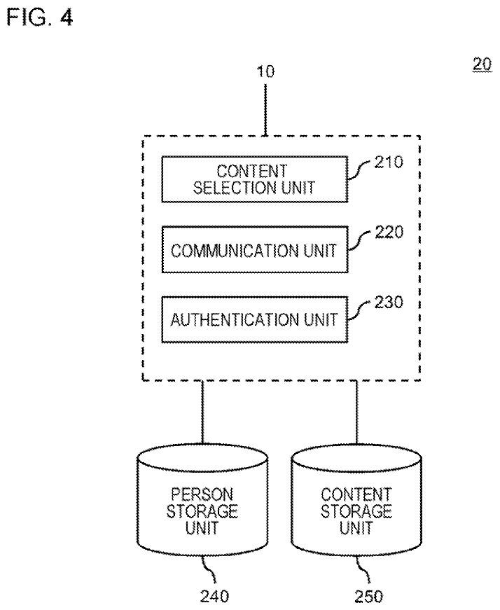

FIG. 4 is a diagram illustrating one example of a functional configuration of the authentication apparatus 20. The authentication apparatus 20 includes a content selection unit 210, a communication unit 220, and an authentication unit 230, and can utilize a person storage unit 240 and a content storage unit 250. In the example illustrated in the present diagram, the person storage unit 240 and the content storage unit 250 are part of the authentication apparatus 20, but may be located external to the authentication apparatus 20.

The person storage unit 240 stores, for each of a plurality of subjects, information related to the subject. One of pieces of information stored by the person storage unit 240 is a facial information to be a master in authentication. Note that, the person storage unit 240 may store, for each of the plurality of subjects, a content to be transmitted to the authentication apparatus 20. One example of the content is information related to a relative of the subject. A specific example of the information is at least one of (A) to (C) described with reference to FIG. 3.

The content storage unit 250 stores a content to be transmitted to the image acquisition apparatus 10.

The content selection unit 210 selects, from the contents stored in the content storage unit 250, a content to be transmitted to the authentication apparatus 20. The content selection unit 210 may select the content by using the information stored in the person storage unit 240, as necessary. Further, the content selection unit 210 may select the content in a predetermined order.

The communication unit 220 transmits a content selected by the content selection unit 210 to the image acquisition apparatus 10. Further, the communication unit 220 acquires an image for authentication from the image acquisition apparatus 10.

The authentication unit 230 performs authentication processing on the subject by using an image acquired by the communication unit 220 and facial information to be a master stored in the person storage unit 240. One example of the processing is processing of determining who the subject is. Further, the authentication unit 230 repeatedly transmits to the image acquisition apparatus 10 as necessary, at least one of a result of the authentication processing and information indicating progress status of the authentication processing, via the communication unit 220. The image acquisition apparatus 10 uses these pieces of information for deciding whether to stop outputting the content.

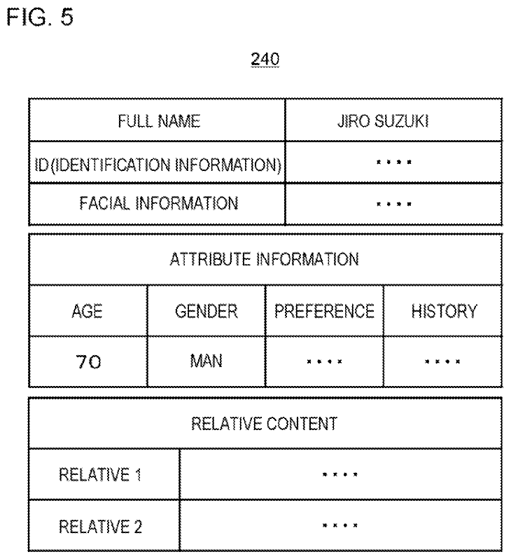

FIG. 5 is a diagram illustrating one example of information stored by the person storage unit 240. The person storage unit 240 stores, for each subject, a name of the subject, identification information, facial information to be a master, attribute information, and a content related to a relative.

The identification information is, for example, an ID assigned to the subject, for example, a character string. The character string may include a number or may be configured of numbers only.

The attribute information stores, for example, age, gender, information indicating preference of the subject, and various pieces of historical information related to the subject. One example of the information indicating the preference of the subject is at least one of a hobby and a type of information that interests the subject (for example, what type of store the subject is interested in, such as a type of restaurant and a beauty salon), but is not limited thereto. One example of the historical information is at least one of a purchase history of an article and a service, a search history of information on the Internet, a browsing history of contents (including contents on the Internet), and a medication history. The attribute information is used, for example, when the content selection unit 210 selects a content.

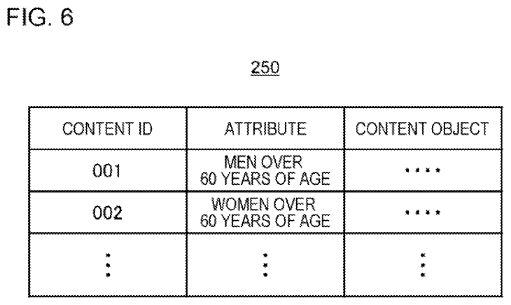

FIG. 6 is a diagram illustrating one example of information stored by the content storage unit 250. The content storage unit 250 stores an object of a content, in association with a content ID and an attribute of a person to be provided with the content. The content ID may indicate an order of the content. Note that, the content storage unit 250 may store, separately from the content ID, information indicating the order of the content, in association with the object of the content. One example of the content is a video including a specific person or character, a video of a sport, a commercial, and the like, but is not limited thereto.

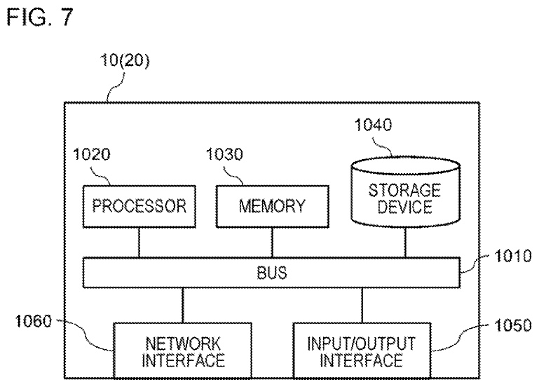

FIG. 7 is a diagram illustrating a hardware configuration example of the image acquisition apparatus 10. The image acquisition apparatus 10 includes a bus 1010, a processor 1020, a memory 1030, a storage device 1040, an input/output interface 1050, and a network interface 1060.

The bus 1010 is a data transmission path for the processor 1020, the memory 1030, the storage device 1040, the input/output interface 1050, and the network interface 1060 to mutually transmit and receive data. However, a method for connecting the processor 1020 and the like with one another is not limited to bus connection.

The processor 1020 is a processor implemented by a central processing unit (CPU), a graphics processing unit (GPU), or the like.

The memory 1030 is a main storage apparatus implemented by a random access memory (RAM) or the like.

The storage device 1040 is an auxiliary storage apparatus implemented by a hard disk drive (HDD), a solid state drive (SSD), a removable medium such as a memory card, a read only memory (ROM) or the like, and includes a storage medium. The storage medium of the storage device 1040 stores a program module that implements each function (for example, the output control unit 110, the image acquisition unit 120, and the communication unit 130) of the image acquisition apparatus 10. By the processor 1020 loading each of the program modules onto the memory 1030 and executing the program module, each function related to the program module is implemented.

The storage medium storing the program module may include a non-transitory tangible medium usable by the computer 1000, and a program code readable by the computer 1000 (the processor 1020) may be embedded in the medium.

The input/output interface 1050 is an interface for connecting the image acquisition apparatus 10 to various input/output devices.

The network interface 1060 is an interface for connecting the image acquisition apparatus 10 to a network. The network is, for example, a local area network (LAN) or a wide area network (WAN). A method by which the network interface 1060 connects to the network may be wireless connection or wired connection. The image acquisition apparatus 10 communicates with the authentication apparatus 20, for example, via the network interface 1060.

Note that, a hardware configuration of the authentication apparatus 20 is similar to the hardware configuration illustrated in FIG. 7. In this case, a storage medium of a storage device 1040 stores a program module that implements each function of the authentication apparatus 20.

The storage medium storing the program module may include a non-transitory tangible medium usable by the computer 1000, and a program code readable by the computer 1000 (the processor 1020) may be embedded in the medium.

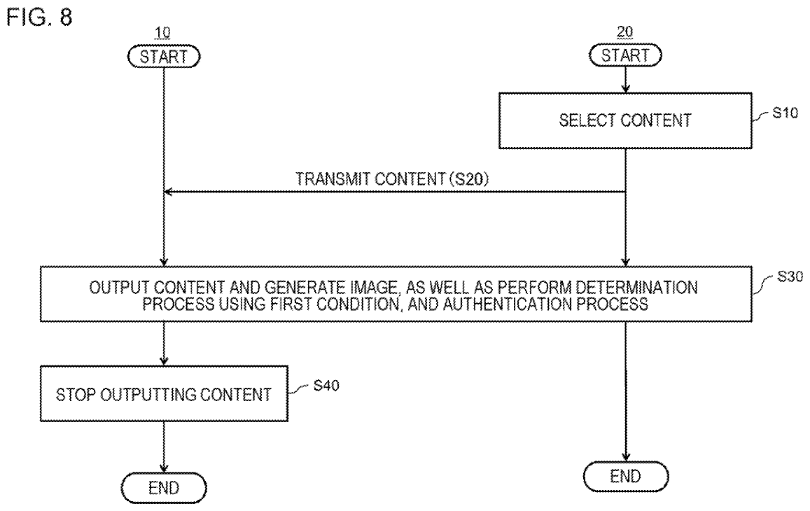

FIG. 8 is a flowchart illustrating one example of processing performed by the image acquisition apparatus 10 and the authentication apparatus 20. Prior to the processing illustrated in the present diagram, the image acquisition apparatus 10 transmits information indicating that authentication processing is started to the authentication apparatus 20. Further, the image acquisition apparatus 10 is positioned in a direction in which the output unit 140 and the image capture unit 150 face to the subject. As one example, the subject operates the image acquisition apparatus 10. As another example, the assistant holds the image acquisition apparatus 10 in a state in which the output unit 140 and the image capture unit 150 face to the subject.

First, the content selection unit 210 of the authentication apparatus 20 selects a content to be output by the image acquisition apparatus 10 (step S10). The communication unit 220 of the authentication apparatus 20 transmits the selected content to the image acquisition apparatus (step S20).

Note that, the image acquisition apparatus 10 may preliminarily store the content. In this case, the processing described in step S10 and step S20 is not performed.

The communication unit 130 of the image acquisition apparatus 10 acquires the content transmitted from the authentication apparatus 20. Then, the output control unit 110 of the image acquisition apparatus 10 causes the output unit 140 to start outputting the content. After that, the image capture unit 150 repeatedly generates images. Further, the communication unit 130 of the image acquisition apparatus 10 transmits the image to the authentication apparatus 20. The authentication unit 230 of the authentication apparatus 20 performs authentication processing by using the image. Then, the output control unit 110 continues to cause the output unit 140 to output the content until the first condition is satisfied (step S30). Further, when the first condition is satisfied, the output control unit 110 stops outputting the content (step S40).

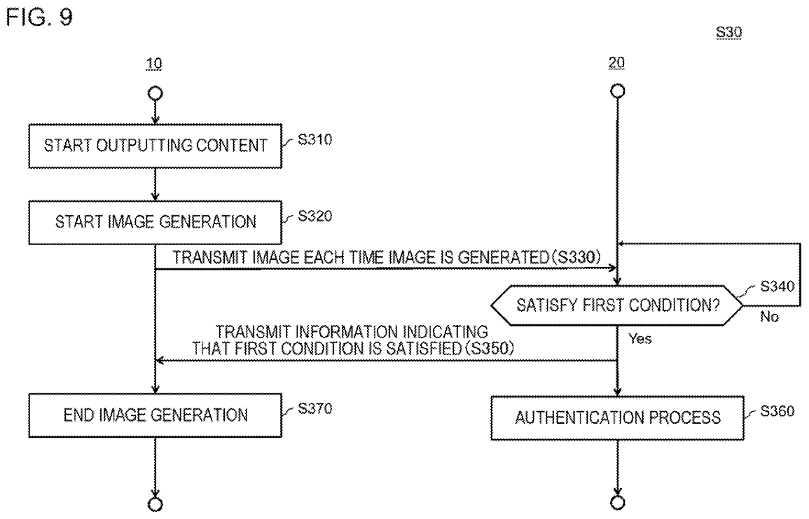

FIG. 9 is a flowchart illustrating a first detailed example of step S30 in FIG. 8. In the example illustrated in the present diagram, the first condition is a condition related to a face of the subject in an image generated by the image capture unit 150, for example, at least one of (1) to (5) described with reference to FIG. 3.

First, the output control unit 110 of the image acquisition apparatus 10 causes the output unit 140 to start outputting the content (step S310). After that, the image capture unit 150 starts generating an image (step S320). At this occasion, the image capture unit 150 repeatedly generates images until the first condition is satisfied. Note that, step S320 may be started prior to step S310. Then, the communication unit 130 of the image acquisition apparatus 10 transmits the image to the authentication apparatus 20 each time the image is generated (step S330).

The authentication unit 230 of the authentication apparatus 20 decides, each time an image is transmitted from the image acquisition apparatus 10, whether the image satisfies the first condition. Further, when the first condition is satisfied (step S340: Yes), the communication unit 220 of the authentication apparatus 20 transmits information indicating that the first condition is satisfied to the image acquisition apparatus 10. Then, the image acquisition apparatus 10 proceeds to step S40, and ends image generation processing by the image capture unit 150 (step S370). Further, the authentication unit 230 performs authentication processing by using the image (step S360).

Note that, when the image transmitted in step S330 does not satisfy the first condition (step S340: No), the processing indicated in step S320 to step S340 is repeated.

Note that, in a flowchart illustrated in FIG. 9, processing of deciding whether the first condition is satisfied is performed by the authentication apparatus 20.

The first condition may be switched dynamically. An example of a method for switching the first condition will be described below.

The authentication apparatus 20 may switch the first condition using existing machine learning techniques or optimization methods. As one example, the authentication apparatus 20 may use a machine learning model that receives as input information relating to a time and frequency at which the authentication processing was performed for the subject and determines the conditions required for the authentication processing for the subject. For example, the input information is historical data relating to authentication processing performed for each subject and stored in an authentication result information storage unit, not shown.

For example, the machine learning model determines that it is enough to satisfy at least one of the conditions (1) through (5) described using FIG. 3 for a subject whose frequency of performing authentication processing is higher than a predetermined threshold or for a subject for whom the number of performing authentication processing within a predetermined period is equal to or more than a predetermined number. For a subject whose frequency of successful authentications is higher than the predetermined threshold or for a subject for whom the number of performing authentication processing within the predetermined period is equal to or more than the predetermined number, the machine learning model may determine that a frequency of requesting authentication should be reduced. On the other hand, for a subject whose frequency of performing authentication processing is not higher than the predetermined threshold or for a subject for whom the number of performing authentication processing within the predetermined period is less than the predetermined number of times, the machine learning model determine that two or more of (1) through (5) described using FIG. 3 must be satisfied.

The authentication apparatus 20 can search for (optimize) the appropriate first condition by using such a machine learning model.

In this way, by using the machine learning model created from historical data relating to the authentication processing, the authentication unit 230 can set a criterion for the authentication processing that can reduce a load of the authentication processing and a burden on the subject as much as possible, while maintaining authentication accuracy.

However, the decision processing may be performed by the image acquisition apparatus 10. In this case, the output control unit 110 of the image acquisition apparatus 10 decides, each time the image capture unit 150 generates an image, whether the image satisfies the first condition. Then, when the first condition is satisfied, the output control unit 110 causes the output unit 140 to stop outputting the content (step S40 in FIG. 8), and the image capture unit 150 ends image generation. Then, the communication unit 130 transmits the image that satisfies the first condition to the authentication apparatus 20.

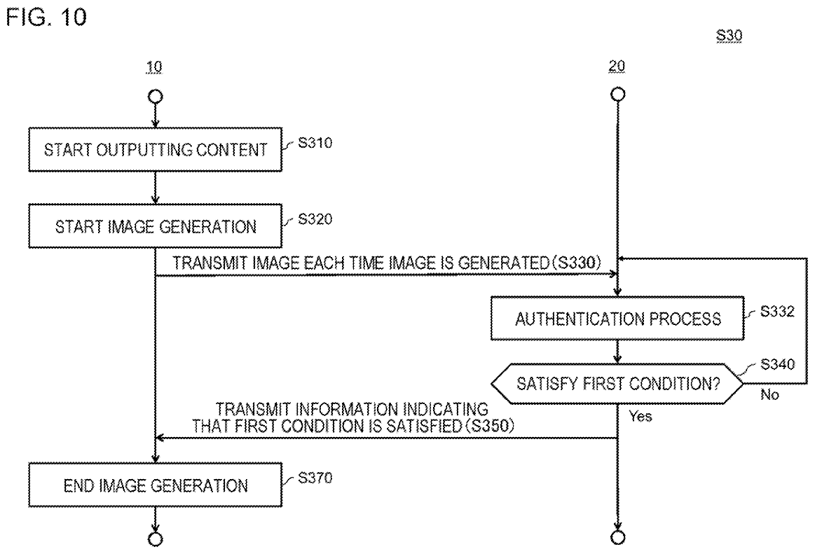

FIG. 10 is a flowchart illustrating a second detailed example of step S30 in FIG. 8. In the example illustrated in the present diagram, the first condition is a condition related to progress of the authentication processing, for example, one of (6) and (7) described with reference to FIG. 3.

Processing in step S310 to step S330 is as described with reference to FIG. 9. The authentication unit 230 of the authentication apparatus 20 performs, each time an image is transmitted, authentication processing by using the image (step S332). Further, when the first condition is satisfied (step S340: Yes), the authentication unit 230 of the authentication apparatus transmits information indicating that the first condition is satisfied to the image acquisition apparatus 10 (step S350). Then, the output control unit 110 causes the output unit 140 to stop outputting the content (step S40 in FIG. 8), and the image capture unit 150 ends image generation.

Note that, when the image does not satisfy the first condition (step S340: No), the processing indicated in step S320 to step S340 is repeated.

As described above, according to the present example embodiment, the image acquisition apparatus 10 includes the output control unit 110. The output control unit 110 continues to cause the output unit 140 to output a content until a first condition being set in order to make face authentication succeed is satisfied. Therefore, the image acquisition apparatus 10 is more likely to acquire an image sufficient to improve authentication accuracy.

### Second Example Embodiment

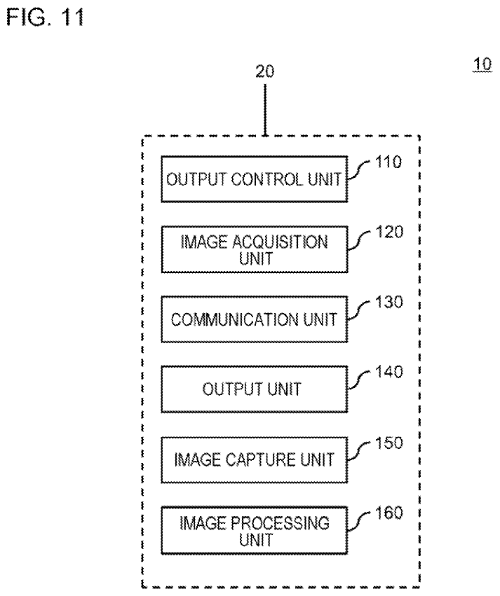

FIG. 11 is a diagram for describing a function of an image acquisition apparatus 10 according to the present example embodiment, and corresponds to FIG. 3 in the first example embodiment. An authentication system according to the present example embodiment is similar to the authentication system according to the first example embodiment, except for a following point.

First, the image acquisition apparatus 10 includes an image processing unit 160. The image processing unit 160 generates, by processing an image acquired by an image acquisition unit 120, state information indicating a state of a subject. The state information is preferably information from which whether the subject is interested in a content output by an output unit 140 can be estimated. As one example, the state information may indicate feeling of the subject, or a line of sight of the subject. When the state information indicates feeling of the subject and the feeling of the subject is pleasure, it can be estimated that the subject is interested in the content. When the state information indicates a line of sight of the subject and the line of sight of the subject is directed to the image acquisition apparatus 10, it can be estimated that the subject is interested in the content.

Further, while continuing to cause the output unit 140 to output the content, an output control unit 110 changes the content to be output according to a predetermined criterion. As an example of a change in the content, there is a case in which a content of the content being output is switched without changing a type of the content, and a case in which the type of the content itself is changed. Herein, the type of the content is, for example, a still image from a relative, a moving image from the relative, a still image on the Internet, a moving image on the Internet, audio from the relative, audio on the Internet, and the like. Further, the predetermined criterion may be that an output time of a content currently being output exceeds a reference value, or may be a criterion related to the state information generated by the image processing unit 160. An example of the latter case is, for example, whether the subject is interested in the content currently being output, or whether the subject is pleased. Further, the output control unit 110 changes the content when the subject is not interested in the content or is not pleased.

For example, when the state information indicates that the subject is not interested in the content currently being output, the output control unit 110 changes a content of the content being output. In this case, an output order of the contents may be set in advance or at random.

The output order of the contents may be an output order optimized using a machine learning model that has learned a correspondence relation between a content and the past state information of the subject for the content. When the output order of the contents is set in advance, the output order may be set in advance based on a degree to which the subject is likely to show interest in each content. The degree of likely interest may be generated using the machine learning model that has learned the correspondence relation between the content and the past state information of the subject for the content. In addition, the output control unit 110 may use the degree to which the subject is likely to show interest to present candidates for the output order of the content to the assistant. At least one or more candidates for the output order of the content may be presented. In this way, for example, even when the assistant sets the output order of the contents, the image acquisition apparatus 10 can assist the assistant in making decisions more easily on the output order of the contents in which the subject is more likely to show interest.

Another method by which the output control unit 110 changes content is, for example, black box model optimization techniques such as Bayesian optimization.

Bayesian optimization is an optimization technique that uses Bayesian statistics to predict and change the optimal content priority using a past behavior and feedback of the subject. Because Bayesian optimization makes the best choice while taking uncertainty into account, it is possible to balance “exploration,” in which new content is tried, with “use,” in which content that has already produced satisfactory results is repeated.

The output control unit 110 can use the state information generated by the image processing unit 160 as feedback for Bayesian optimization.

If the subject's feedback data for the content is accumulated by using Bayesian optimization, the output control unit 110 may build a machine learning model that learns a relationship between the content and the subject's feedback.

For example, if the accuracy of the machine learning model exceeds a predetermined threshold, the output control unit 110 may switch the method of determining the content to be output to the subject from Bayesian optimization to the machine learning model.

This enables the output control unit 110 to provide content appropriate for each individual subject.

Further, the predetermined criterion may be that a predetermined input is made to the image acquisition apparatus 10. The predetermined input is, for example, that a finger or the like touches any point, or a predetermined area of a touch panel included in the image acquisition apparatus 10. Further, an image generated by the image acquisition apparatus 10 may be transmitted to a terminal other than an authentication apparatus 20, for example, a terminal operated by an assistant. In this case, the predetermined criterion may be that a predetermined input is made to the terminal to which the image is transmitted, for example, that a touch panel displaying the image generated by the image acquisition apparatus 10 is touched.

Also, according to the present example embodiment, the output control unit 110 continues to cause the output unit 140 to output a content until a first condition being set in order to make face authentication succeed is satisfied. Further, the output control unit 110 changes the content to be output, according to a predetermined criterion. Therefore, the image acquisition apparatus 10 is furthermore likely to acquire an image sufficient to improve authentication accuracy.

### Third Example Embodiment

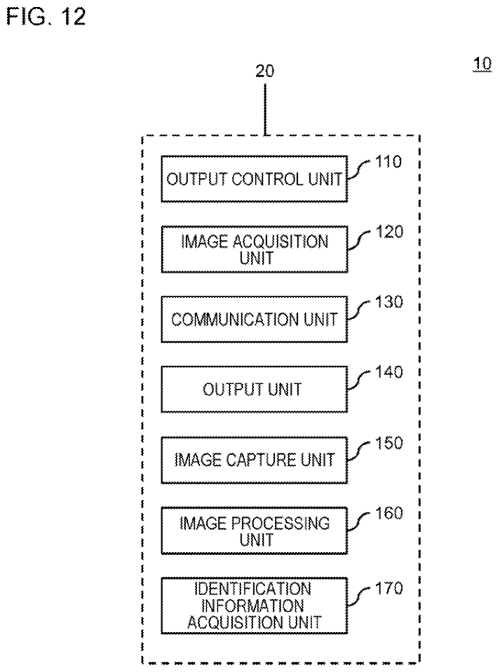

FIG. 12 is a diagram illustrating one example of a functional configuration of an image acquisition apparatus 10 according to the present example embodiment. A function of an authentication system according to the present example embodiment is similar to that of the authentication system according to the first example embodiment or the second example embodiment, except for a following point.

First, the image acquisition apparatus 10 includes an identification information acquisition unit 170. Before authentication processing using facial information is performed, the identification information acquisition unit 170 acquires identification information of a subject, for example, an ID assigned to the subject or a name of the subject. An operator (for example, the subject or an assistant) of the image acquisition apparatus 10 may input the identification information of the subject to the image acquisition apparatus 10 via a keyboard, or a touch panel included in the image acquisition apparatus 10. Further, the operator may input the identification information of the subject to the image acquisition apparatus 10 by reading code information indicating the identification information into the image acquisition apparatus 10. The code information may be a bar code or a two-dimensional code. Further, the operator may input the identification information of the subject to the image acquisition apparatus 10 by reading a storage medium storing the identification information into the image acquisition apparatus 10 or communicating with the image acquisition apparatus 10.

Further, a communication unit 130 of the image acquisition apparatus 10 transmits the identification information acquired by the identification information acquisition unit 170 to an authentication apparatus 20. Further, a content selection unit 210 of the authentication apparatus 20 selects, by using the identification information, a content to be transmitted to the image acquisition apparatus 10.

For example, the content selection unit 210 may read a content of the relative associated with the identification information from a person storage unit 240, and transmit the content of the relative to the image acquisition apparatus 10 via a communication unit 220.

Further, the content selection unit 210 may read attribute information associated with the identification information from the person storage unit 240, read a content associated with the attribute information from a content storage unit 250, and transmits the content to the image acquisition apparatus 10 via the communication unit 220. In this case, the content selection unit 210 may read a plurality of contents from the content storage unit 250. In this case, the content selection unit 210 may determine a priority order of the content, according to a predetermined criterion. The predetermined criterion is, for example, that a priority order of attributes is set in advance. One example of the priority order is to give first priority to a content of a matching age, give second priority to a content of a matching gender, and give third priority to a content included in a history, and the like. In addition, the priority order may be set to an order optimized using a machine learning model that has learned a correspondence relation between the content, the state information of the subject for the content, and the attribute information of the subject. Further, when a content to be output by an output unit 140 is changed according to the predetermined criterion, the output control unit 110 of the image acquisition apparatus 10 determines an output order of the content, according to the priority order.

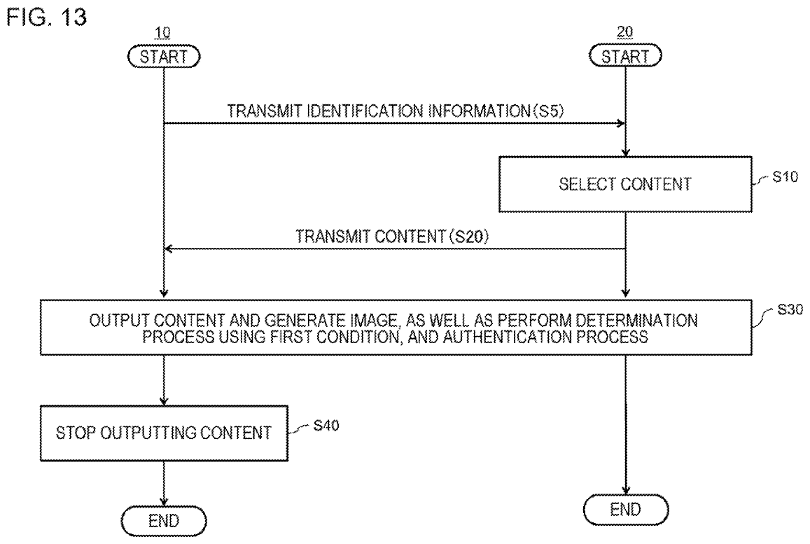

FIG. 13 is a flowchart illustrating one example of processing performed by the image acquisition apparatus 10 and the authentication apparatus 20, and corresponds to FIG. 8 in the first example embodiment.

First, the identification information acquisition unit 170 of the image acquisition apparatus 10 acquires identification information of a subject. Further, the communication unit 130 of the image acquisition apparatus 10 transmits the identification information to the authentication apparatus 20 (step S5). Then, the content selection unit 210 of the authentication apparatus 20 selects a content by using the identification information (step S10). Subsequent processing is similar to that in the first example embodiment or the second example embodiment.

According to the present example embodiment, the output unit 140 of the image acquisition apparatus 10 can output, for each subject, a content being highly likely to be interested by the subject. Therefore, the image acquisition apparatus 10 is furthermore likely to acquire an image sufficient to improve authentication accuracy.

Although the example embodiments of the present invention are described above with reference to the drawings, these example embodiments are examples of the present invention, and various configurations other than the above description may be adopted.

For example, functional assignment for the image acquisition apparatus 10 and the authentication apparatus 20 is not limited to the above-described example.

For example, the image acquisition apparatus 10 may include an authentication unit 230. In this case, the output control unit 110 may divide a display included in the output unit 140 into a plurality of areas, and causes an image generated by an image capture unit 150 to be displayed in one area and cause a result of authentication by the authentication unit 230 to be displayed in another area.

Further, the image acquisition apparatus 10 may include the content selection unit 210, and may further include the person storage unit 240 and the content storage unit 250. Further, the image acquisition apparatus 10 may include all functions of the authentication apparatus 20.

Conversely, the authentication apparatus 20 may include the output control unit 110, may include an image acquisition unit 120, or may include both the output control unit 110 and the image acquisition unit 120. Further, the authentication apparatus 20 may include an image processing unit 160 described in the second example embodiment.

Further, in a plurality of the flowcharts used in the above description, a plurality of processes (pieces of processing) are described in order, however, an execution order of the processes executed in each example embodiment is not limited to the described order. In each example embodiment, the illustrated execution order of processes can be modified without affecting contents of the processes. Further, each of the above-described example embodiments may be combined without conflicting with each other.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

1. An image acquisition apparatus including:
an output control unit that causes an output unit to output a content; and
an image acquisition unit that acquires an image generated by an image capture unit located in a position where a face of a person can be captured when the person faces to the output unit, the image includes the person and is an image for authentication, wherein
the output control unit continues to cause the output unit to output the content until a first condition being set in order to make authentication succeed is satisfied.
   2. The image acquisition apparatus according to supplementary note 1, wherein
the first condition is a condition related to a face of the person in the image.
   3. The image acquisition apparatus according to supplementary note 2, wherein
the first condition relates to at least one of sharpness of a face, color of a face, size of a face, and a face part included in the image.
   4. The image acquisition apparatus according to supplementary note 1, wherein
the first condition is that the authentication is succeeded, or processing related to the authentication is ended.
   5. The image acquisition apparatus according to any one of supplementary notes 1 to 4, wherein
the content is information that changes over time.
   6. The image acquisition apparatus according to any one of supplementary notes 1 to 5, wherein
the content is information related to a relative of the person.
   7. The image acquisition apparatus according to any one of supplementary notes 1 to 6, wherein
the output control unit changes the content according to a predetermined criterion while continuing to cause the output unit to output the content.
   8. The image acquisition apparatus according to supplementary note 7, wherein
state information indicating a state of a person included in the image is generated by processing the image, and
the predetermined criterion relates to the state information.
   9. The image acquisition apparatus according to any one of supplementary notes 1 to 8, further including
an identification information acquisition unit that acquires identification information that is information different from the image and is for identifying the person, wherein
the content is selected by using the identification information.
   10. The image acquisition apparatus according to any one of supplementary notes 1 to 9, further including:
the output unit; and
the image capture unit.
   11. The image acquisition apparatus according to any one of supplementary notes 1 to 10, further including
an authentication unit that performs authentication processing on the person by using the image.
   12. An authentication system, including:
an output control unit that causes an output unit to output a content;
an image acquisition unit that acquires an image generated by an image capture unit located in a position where a face of a person can be captured when the person faces to the output unit, the image includes the person and is an image for authentication; and
an authentication unit that performs authentication processing on the person by using the image, wherein
the output control unit continues to cause the output unit to output the content until a first condition being set in order to make authentication succeed is satisfied.
   13. The authentication system according to supplementary note 12, wherein
the first condition is a condition related to a face of the person in the image.
   14. The authentication system according to supplementary note 13, wherein
the first condition relates to at least one of sharpness of a face, color of a face, size of a face, and a face part included in the image.
   15. The authentication system according to supplementary note 12, wherein
the first condition is that the authentication is succeeded, or processing related to the authentication is ended.
   16. The authentication system according to any one of supplementary notes 12 to 15, wherein
the content is information that changes over time.
   17. The authentication system according to any one of supplementary notes 12 to 16, wherein
the content is information related to a relative of the person.
   18. The authentication system according to any one of supplementary notes 12 to 17, wherein
the output control unit changes the content according to a predetermined criterion while continuing to cause the output unit to output the content.
   19. The authentication system according to supplementary note 18, wherein
state information indicating a state of a person included in the image is generated by processing the image, and
the predetermined criterion relates to the state information.
   20. The authentication system according to any one of supplementary notes 12 to 19, further including
an identification information acquisition unit that acquires identification information that is information different from the image and is for identifying the person, wherein
the content is selected by using the identification information.
   21. The authentication system according to any one of supplementary notes 12 to 20, further including:
the output unit;
and the image capture unit.
   22. An image acquisition method including, by a computer:
causing an output unit to output a content;
acquiring an image generated by an image capture unit located in a position where a face of a person can be captured when the person faces to the output unit, the image includes the person and is an image for authentication; and
continuing to cause the output unit to output the content until a first condition being set in order to make authentication succeed is satisfied.

23. The image acquisition method according to supplementary note 22, wherein
the first condition is a condition related to a face of the person in the image.
   24. The image acquisition method according to supplementary note 23, wherein
the first condition relates to at least one of sharpness of a face, color of a face, size of a face, and a face part included in the image.
   25. The image acquisition method according to supplementary note 22, wherein
the first condition is that the authentication is succeeded, or processing related to the authentication is ended.
   26. The image acquisition method according to any one of supplementary notes 22 to 25, wherein
the content is information that changes over time.
   27. The image acquisition method according to any one of supplementary notes 22 to 26, wherein
the content is information related to a relative of the person.
   28. The image acquisition method according to any one of supplementary notes 22 to 27, further including, by a computer,
changing the content according to a predetermined criterion while continuing to output the content.
   29. The image acquisition method according to supplementary note 28, wherein
state information indicating a state of a person included in the image is generated by processing the image, and
the predetermined criterion relates to the state information.
   30. The image acquisition method according to any one of supplementary notes 22 to 29, further including, by the computer,
acquiring identification information that is information different from the image and is for identifying the person, wherein
the content is selected by using the identification information.
   31. The image acquisition method according to any one of supplementary notes 22 to 30, further including, by the computer,
controlling the output unit and the image capture unit.
   32. The image acquisition method according to any one of supplementary notes 22 to 31, further including, by the computer,
performing authentication processing on the person by using the image.
   33. An authentication method including,
by an authentication system:
causing an output unit to output a content;
acquiring an image generated by an image capture unit located in a position where a face of a person can be captured when the person faces to the output unit, the image includes the person and is an image for authentication;
performing authentication processing on the person by using the image; and
continuing to cause the output unit to output the content until a first condition being set in order to make authentication succeed is satisfied.
   34. The authentication method according to supplementary note 33, wherein
the first condition is a condition related to a face of the person in the image.
   35. The authentication method according to supplementary note 34, wherein
the first condition relates to at least one of sharpness of a face, color of a face, size of a face, and a face part included in the image.
   36. The authentication method according to supplementary note 33, wherein
the first condition is that the authentication is succeeded, or processing related to the authentication is ended.
   37. The authentication method according to any one of supplementary notes 33 to 36, wherein
the content is information that changes over time.
   38. The authentication method according to any one of supplementary notes 33 to 37, wherein
the content is information related to a relative of the person.
   39. The authentication method according to any one of supplementary notes 33 to 38, further including, by the authentication system,
changing the content according to a predetermined criterion while continuing to cause the output unit to output the content.
   40. The authentication method according to supplementary note 39, wherein,
state information indicating a state of a person included in the image is generated by processing the image, and
the predetermined criterion relates to the state information.
   41. The authentication method according to supplementary notes 33 to 40, further including, by the authentication system,
acquiring identification information that is information different from the image and is for identifying the person, wherein
the content is selected by the identification information.
   42. The authentication method according to any one of supplementary notes 33 to 41, further including, by the authentication system,
including the output unit and the image capture unit.
   43. A program causing a computer to function as:
an output control unit that causes an output unit to output a content; and
an image acquisition unit that acquires an image generated by an image capture unit located in a position where a face of a person can be captured when the person faces to the output unit, the image includes the person and is an image for authentication, wherein
the output control unit continues to cause the output unit to output the content until a first condition being set in order to make authentication succeed is satisfied.
   44. The program according to supplementary note 43, wherein
the first condition is a condition related to a face of the person in the image.
   45. The program according to supplementary note 44, wherein
the first condition relates to at least one of sharpness of a face, color of a face, size of a face, and face part included in the image.
   46. The program according to supplementary note 43, wherein
the first condition is that the authentication is succeeded, or processing related to the authentication is ended.
   47. The program according to any one of supplementary notes 43 to 46, wherein
the content is information that changes over time.
   48. The program according to any one of supplementary notes 43 to 47, wherein
the content is information related to a relative of the person.
   49. The program according to any one of supplementary notes 43 to 48, further causing the computer to
change the content according to a predetermined criterion while continuing to cause the output unit to output the content.
   50. The program according to supplementary note 49, wherein
state information indicating a state of a person included in the image is generated by processing the image, and
the predetermined criterion relates to the state information.
   51. The program according to any one of supplementary notes 43 to 50, further causing the computer to
acquire identification information that is information different from the image and is for identifying the person, wherein
the content is selected by using the identification information.
   52. The program according to any one of supplementary notes 43 to 51, further causing the computer to
control the output unit and the image capture unit.
   53. The program according to any one of supplementary notes 43 to 52, further causing the computer to
perform authentication processing on the person by using the image.
   54. A storage medium recording the program according to any one of supplementary notes 43 to 53.
   55. The image acquisition apparatus according to any one of supplementary notes 1 to 11, wherein
the output control unit causes the output unit to output the content optimized by using a machine learning model.
   56. The image acquisition apparatus according to any one of supplementary notes 1 to 11, and 55, wherein
the output control unit causes the output unit to output the content according to a priority of the content optimized by using a machine learning model.
   57. The image acquisition apparatus according to any one of supplementary notes 1 to 11, and 55 to 56, wherein
the first condition is set based on at least one of time or frequency at which the authentication for the person has been performed.
   58. The authentication system according to any one of supplementary notes 12 to 21, wherein
the output control unit causes the output unit to output the content optimized by using a machine learning model.
   59. The authentication system according to any one of supplementary notes 12 to 21 and 58, wherein
the output control unit causes the output unit to output the content according to a priority of the content optimized by using a machine learning model.
   60. The authentication system according to any one of supplementary notes 12 to 21 and 58 to 59, wherein
the first condition is set based on at least one of time or frequency at which the authentication for the person has been performed.
   61. The image acquisition method according to any one of supplementary notes 22 to 32, further including, by the computer,
causing the output unit to output the content optimized by using a machine learning model.
   62. The image acquisition method according to any one of supplementary notes 22 to 32 and 61, further including, by the computer,
causing the output unit to output the content according to a priority of the content optimized by using a machine learning model.
   63. The image acquisition method according to any one of supplementary notes 22 to 32 and 61 to 62, wherein
the first condition is set based on at least one of time or frequency at which the authentication for the person has been performed.
   64. The authentication method according to any one of supplementary notes 33 to 42. further including, by the computer,
causing the output unit to output the content optimized by using a machine learning model.
   65. The authentication method according to any one of supplementary notes 33 to 42 and 64. further including, by the computer,
causing the output unit to output the content according to a priority of the content optimized by using a machine learning model.
   66. The authentication method according to any one of supplementary notes 33 to 42 and 64 to 65, wherein
the first condition is set based on at least one of time or frequency at which the authentication for the person has been performed.
   67. A program according to any one of supplementary notes 43 to 54, further causing the computer to cause the output unit to output the content optimized by using a machine learning model.
   68. A program according to any one of supplementary notes 43 to 54 and 67, further causing the computer to cause the output unit to output the content according to a priority of the content optimized by using a machine learning model.
   69. A program according to any one of supplementary notes 43 to 54 and 67 to 68, wherein
the first condition is set based on at least one of time or frequency at which the authentication for the person has been performed.
   70. A non-transitory computer-readable storage medium storing the program according to any one of supplementary notes 43 to 54 and 67 to 69.

What is claimed is:

1. An image acquisition apparatus comprising:
at least one memory configured to store instructions; and
at least one processor configured to execute the instructions to:
cause an output unit to output a content;
acquire an image generated by an image capture unit located in a position where a face of a person can be captured when the person faces to the output unit, the image includes the person and is an image for authentication; and
continue to cause the output unit to output the content until a first condition being set in order to make authentication succeed is satisfied.

2. The image acquisition apparatus according to claim 1, wherein
the first condition is a condition related to the face of the person in the image.

3. The image acquisition apparatus according to claim 2, wherein
the first condition relates to at least one of sharpness of a face, color of a face, size of a face, and a face part included in the image.

4. The image acquisition apparatus according to claim 1, wherein
the first condition is that the authentication is succeeded, or processing related to the authentication is ended.

5. The image acquisition apparatus according to claim 1, wherein
the at least one processor is further configured to execute the instructions to change the content according to a predetermined criterion while continuing to cause the output unit to output the content.

6. The image acquisition apparatus according to claim 5, wherein
the at least one processor is further configured to execute the instructions to generate, by processing the image, state information indicating a state of a person included in the image, and
the predetermined criterion relates to the state information.

7. The image acquisition apparatus according to claim 1, wherein
the at least one processor is further configured to:
acquire identification information that is information different from the image and is for identifying the person, wherein
cause the output unit to output the content selected by using the identification information.

8. The image acquisition apparatus according to claim 1, wherein
the at least one processor is further configured to perform authentication processing on the person by using the image.

9. The image acquisition apparatus according to claim 1, wherein
the at least one processor is further configured to cause the output unit to output the content optimized by using a machine learning model.

10. The image acquisition apparatus according to claim 1, wherein
the at least one processor is further configured to cause the output unit to output the content according to a priority of the content optimized by using a machine learning model.

11. The image acquisition apparatus according to claim 1, wherein
the first condition is set based on at least one of time or frequency at which the authentication for the person has been performed.

12. An image acquisition method comprising,
by a computer:
causing an output unit to output a content;
acquiring an image generated by an image capture unit located in a position where a face of a person can be captured when the person faces to the output unit, the image includes the person and is an image for authentication; and
continuing to cause the output unit to output the content until a first condition being set in order to make authentication succeed is satisfied.

13. A non-transitory computer-readable storage medium storing a program causing a computer to execute:
a process of causing an output unit to output a content;
a process of acquiring an image generated by an image capture unit located in a position where a face of a person can be captured when the person faces to the output unit, the image includes the person and is an image for authentication; and
a process of continuing to cause the output unit to output the content until a first condition being set in order to make authentication succeed is satisfied.
